(19) United States
(12) Patent Application Publication
(10) Pub. No.: US 2003/0149756 A1
(43) Pub. Date: Aug. 7, 2003

(54) Configuration management method and system

(76) Inventors: David Grieve, Durham, NH (US); James Richmond, Newfields, NH (US)

Correspondence Address: Gary S. Engelson, Wolf, Greenfield & Sacks, P.C., Federal Reserve Plaza, 600 Atlantic Avenue, Boston, MA, 02110, US

(21) Appl. No.: 10/140,765

(22) Filed: May 8, 2002

Related U.S. Application Data
(60) Provisional application No. 60/354,712, filed on Feb. 6, 2002.

(51) Int. Cl. G06F 15/173; G06F 15/177

(52) U.S. Cl. 709/223; 709/220

(57) ABSTRACT

A method of managing a computer network includes comparing a first configuration file representing a network device configuration at a point in time with a second configuration file representing a network device configuration at an earlier point in time; and indicating when a difference exists between the first configuration file and the second configuration file. A system for managing a computer network comprises a memory in which is stored configuration files corresponding to plural network devices at plural points in time; a database in which is stored a history of configuration file usage; and an agent that retrieves from a network device a configuration file and determines when the configuration file retrieved differs from a stored configuration file corresponding to a different point in time. Alternatively, a system for maintaining configuration of a computer network comprises a data store of configuration files, each stored configuration file holding a configuration of a device at a time; and an agent that downloads a current configuration file holding a current configuration from the device and compares the current configuration with the configuration of the device at the time, storing the current configuration in the data store when the current configuration differs from the configuration of the device at the time and identifying differences to an operator.

### BACKGROUND OF THE INVENTION

1. Field of the Invention

The disclosure relates to systems and methods for managing computer network devices in a computer network. More particularly, the disclosure relates to managing configuration and configuration changes in such devices and networks.

2. Related Art

Conventionally, configuration management is performed by large software systems running on computers connected to the network devices either through the network to be managed or through a back channel connection, i.e., a communication channel not part of the network. Such systems attempt to model each network device whose configuration is to be managed, so that an operator can review the functionality specified by each configuration parameter and combination of parameters. Thus, an operator has an opportunity to intelligently analyze a set of configurations for a device or group of devices and determine whether that configuration makes sense for the current state of the network, as then known by the operator. Conventional systems strive to give network operators complete, or near complete, knowledge of the current configuration of each device on a network, so that corrections and updates to the network can be made on the basis of the operator's thorough understanding and analysis of the various device configurations.

As networks have proliferated, and the number and types of devices contained in networks have ballooned, the complexity of the systems required to manage configurations has grown correspondingly. For example, the number and complexity of the network device models that need to be supported continues to grow exponentially. Moreover, the number of individual instances of such devices in each network also continues to grow exponentially. Fundamentally, the paradigm of network configuration management continues to be one of modeling the network device configurations as completely as possible, so that intelligent configuration decisions can be centrally made.

### SUMMARY OF THE INVENTION

It is a general object of the present invention to provide an improved method and system for managing network configuration.

According to an exemplary embodiment of aspects of the invention, there is a method of managing a computer network comprising comparing a first configuration file representing a network device configuration at a point in time with a second configuration file representing a network device configuration at an earlier point in time; and indicating when a difference exists between the first configuration file and the second configuration file. This method may further include, after passage of a period of time, repeating comparing and indicating. The method may yet further include repeating comparing and indicating after passage of regular intervals of time. Alternatively, the method may include identifying as representing a known good state, the second configuration file; and recommending returning to the known good state by loading the second configuration file, when the difference is indicated. In yet another alternative, the method may include storing with each configuration file an identification of a responsible operator; and querying the responsible operator concerning a nature of the first configuration file when the difference is indicated.

According to an exemplary embodiment of other aspects of the invention, there is a system for managing a computer network comprising a memory in which is stored configuration files corresponding to plural network devices at plural points in time; a database in which is stored a history of configuration file usage; and an agent that retrieves from a network device a configuration file and determines when the configuration file retrieved differs from a stored configuration file corresponding to a different point in time.

According to an exemplary embodiment of yet other aspects of the invention, there is a system for maintaining configuration of a computer network comprising a data store of configuration files, each stored configuration file holding a configuration of a device at a time; and an agent that downloads a current configuration file holding a current configuration from the device and compares the current configuration with the configuration of the device at the time, storing the current configuration in the data store when the current configuration differs from the configuration of the device at the time and identifying differences to an operator.

### BRIEF DESCRIPTION OF THE DRAWINGS

In the drawings in which like reference designations indicate like elements:

FIG. 1 is a functional block diagram of the software components of an embodiment of an aspect of the invention;

FIG. 2 is a schematic representation of the layout of a user interface window of the exemplary embodiment;

FIG. 3 is a schematic representation of the layout of another user interface window of the exemplary embodiment;

FIG. 4 is a schematic representation of the layout of another user interface window of the exemplary embodiment;

FIG. 5 is a schematic representation of the layout of another user interface window of the exemplary embodiment;

FIG. 6 is a schematic representation of the layout of another user interface window of the exemplary embodiment;

FIG. 7 is a schematic representation of the layout of another user interface window of the exemplary embodiment;

FIG. 8 is a schematic representation of the layout of another user interface window of the exemplary embodiment;

FIG. 9 is a schematic representation of the layout of another user interface window of the exemplary embodiment;

FIG. 10 is a schematic representation of the layout of another user interface window of the exemplary embodiment;

FIG. 11 is a flow chart of a process of an operator interacting with a user interface software component of the exemplary embodiment;

FIG. 12 is a flow chart of a scheduler process of the exemplary embodiment; and

FIGS. 13 and 14 combined are a flow chart of an agent process of the exemplary embodiment.

### DETAILED DESCRIPTION

The present inventors have discovered, among other things, that a fundamental paradigm shift away from the conventional line of thinking would break the logjam caused by the ever-increasing complexity required by the conventional paradigm.

Rather than attempting to model each and every configuration setting of each and every network device, the paradigm disclosed is based upon tracking the history of configurations and configuration changes over a period of time. The history may be annotated to include information about which configurations are good and which bad, as well as about the nature of particular changes made.

The inventors' new paradigm can be viewed as more holistic than conventional network management. In contrast with the conventional thinking, which is narrow and detail-oriented, under which the operator must understand each setting of each device before changes can be made or evaluated, the new paradigm permits very large, complex networks to be configured and maintained in a valid, working state by providing to the operator a view of the history of configurations of the network devices that help the operator understand the evolutionary steps that produce working and non-working networks. The operator can thus use the experience garnered from previous configurations to produce new, valid configurations, whenever network devices are added, removed or swapped, throughout the system.

In support of this new paradigm, the focus of technology for achieving the inventors' network management aims is different from that of conventional systems. Rather than rely to a great extent on the ability to model network devices and parse their configurations in great detail, though these features may be included in systems embodying aspects of the invention, the new paradigm relies, among other technologies, more heavily on database technology, communication technology, and combinations of database and communication technology with other technologies as explained below.

### General Description

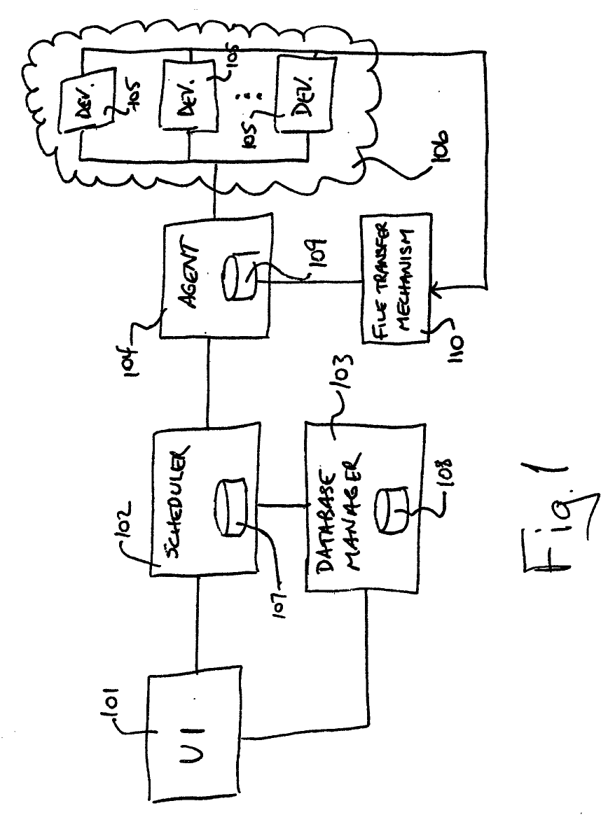

A system embodying aspects of the invention, as shown in FIG. 1, includes a user interface software component 101, a scheduler software component 102, a database management software component 103 and an agent software component 104. In some embodiments, the four software components all execute on one computer system. Alternatively, the agent software component 104 executes on one computer system, as a server, while the other components execute as clients on another computer system. Other partitions are also possible, as will occur to the skilled artisan. The agent 104 communicates with the network devices 105 comprising a computer network 106. Network devices 105 may be routers, switches, etc. Configuration information can be stored in local file store 109 and transferred into and out of network devices 105 by file transfer mechanism 110. File transfer mechanism 110 can employ various file transfer protocols, as explained below.

In the exemplary embodiment described, the software components 101-104 and 109 are implemented in the Java programming language. The software components are thus platform-independent. The scheduler 102 and the agent 104 communicate with each other using Remote Method Indication, a feature of Java, while the agent 104 communicates with network devices 105 using Simple Network Messaging Protocol (SNMP). The file transfer mechanism 110 can use the File Transfer Protocol (FTP), Trivial File Transfer Protocol (TFTP), RCP (remote copy) or HyperText Transfer Protocol (HTTP), or other file transfer protocols which are known in the art.

The user interface (UI) 101 receives inputs from, and provides outputs to, an operator. The UI 101 may be special purpose software written for the express purpose of communicating configuration information to and from an operator, or may be general-purpose software such as a web browser, which becomes a UI when an appropriate HyperText Markup Language (HTML) page or other information in any suitable form is loaded from a web server or a database. The UI may optionally include functions, modules or other elements that parse at,least some configuration file types into a human-readable form that can be presented to the operator as one of the outputs to the operator. The parsing function can be embedded in the HTML page in such an embodiment. The UI can also, optionally, link to special-purpose or general-purpose editors that can edit the contents of configuration files. The UI 101 further has interfaces with the scheduler 102 and the database manager 103, through which actions commanded by the operator inputs are executed, and through which responses are returned for the purpose of providing outputs to the operator. The UI 101 is described in greater detail below.

Messages defining actions to be taken, data to be stored or data that has been received for display or other processing, and responses to requested actions, etc., are sent by the scheduler 102 to the agent 104 for further action. For example, a user input to the UI 101 that indicates a desire to retrieve a configuration from a network device 105 places an event on the event queue 107 of the scheduler 102. The scheduler 102 gets to that event, in turn, as it walks the queue 107, and in response sends a message to the agent 104. When the agent 104 receives the message, the retrieval request is then acted upon, and a response message generated. The response returns to the UI 101 through the scheduler 102 in the same manner. The scheduler 102 and examples of operations performed by the exemplary embodiment are described in more detail below.

The database manager 103 maintains one or more databases 108 useful to the system. For the purposes of this discussion, data is described as being stored in one of several databases 108, each of which is associated with a particular function or type of data stored. However, as will be understood by the skilled artisan, the organization of the data into one or more than one database is an exercise left to the skilled designer who will take into consideration such factors as data store size, ease of data access, complexity of data relationships, etc. As noted above, for convenience of the following discussion, the artifice of several separate databases (one possible embodiment) is maintained. The databases managed include, but need not be limited to a database of configuration information optionally including annotations. The databases can also include a device information database and a schedules database. The device information database stores device attributes and a pointer or reference to a configuration file. Each time a device configuration is read, a new record is appended for the device. Each such record appended is time stamped, permitting the data to be retrieved or presented in a historical view. The schedules database provides for persistence of operational schedules between executions of the system. Schedule record attributes include the date and time an operation is due, the device or group an operation is to be performed on and the operation to be performed. The schema of the exemplary configuration database is discussed further, in relevant part, below.

Finally, the agent 104 is the brain of the system, actually conducting inquiries, returning configuration information, comparing old and new configurations, downloading and uploading device firmware, directing the storage of configuration files or firmware files when configuration or firmware changes are detected, and directing updates to the configuration history database when changes are detected. The agent of the exemplary embodiment maintains a store 109 of configuration files, as well as any other information required locally by the agent, separately from the databases 108 managed by the database manager 103. The store 109 of configuration files could, however, be stored with the databases 108 or elsewhere.

The elements of the system and typical operations thereof are now described in more detail.

### The User Interface

The UI 101 can be a specially constructed software component that executes under one of the Windows™ operating systems available from Microsoft®, the SunOS operating system available from Sun Microsystems, Inc., the MacOS operating system available from Apple Computer or the like. As such, it may present one or more windows and dialog boxes through which an operator enters commands and data, and through which data outputs are presented to the operator. Alternatively, the UI can be constructed of a database of files written in a markup language, e.g., Hyper Text Markup Language (HTML) or Extensible Markup Language (XML), that are presented through a conventional web browser, such as Microsoft's Internet Explorer or AOL Time-Warner's Netscape Navigator. The skilled artisan will understand that there are many suitable options for obtaining input from and providing output to an operator.

In the exemplary embodiment, the UI 101 does not directly interact with the agent 104. Rather, the UI 101 of the exemplary embodiment makes changes to the network device mapping database (part of 108) or to the schedule database 107, only. The scheduler 102 simply reacts to the contents of the event queue in schedule database 107 and the databases 108.

Operation of the exemplary system is now described from the point of view of an operator interacting with the UI 101.

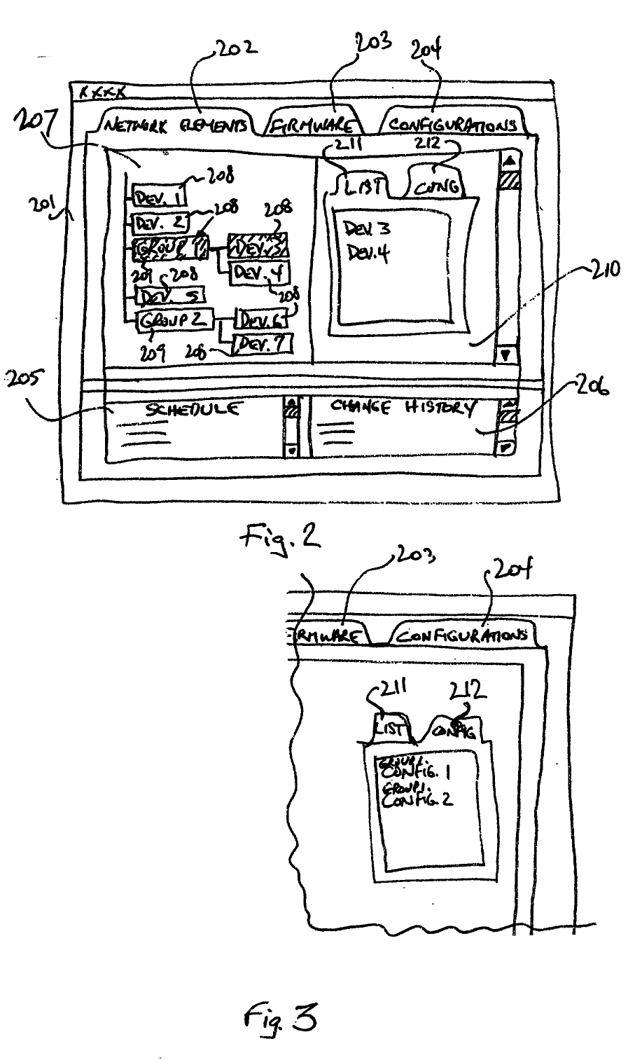

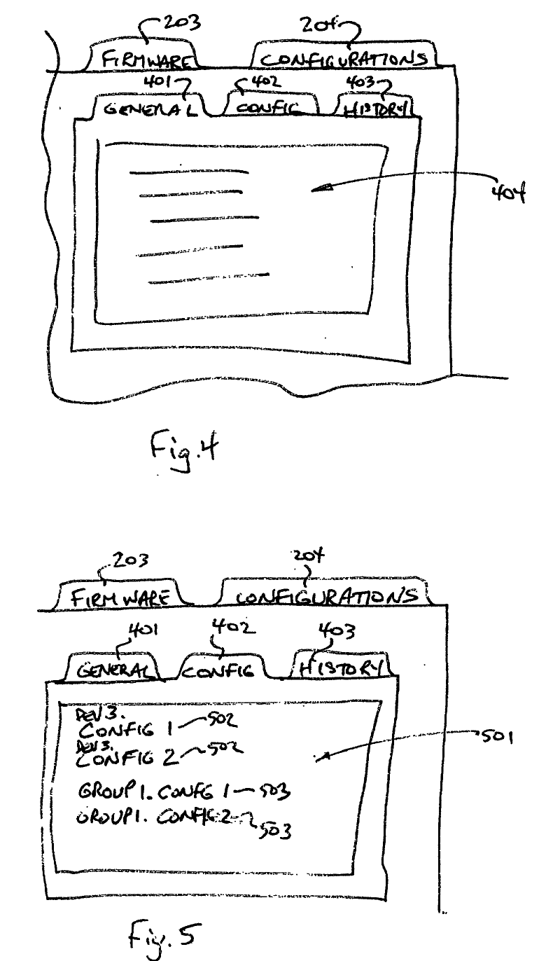

The exemplary UI 101 is organized primarily around devices, configurations and firmware. The UI 101 presents a window 201, as shown in FIG. 2, containing three main tabs 202, 203, 204:

1. Network Elements 202, which displays lists of devices and device groupings;

2. Firmware 203, which displays a list of firmware images organized by device type; and

3. Configurations 204, which displays a list of saved configuration files organized by configuration name or by date.

There is also space set aside in the main window for the schedule summary 205 and for the change history 206.

The Network Elements tab 202 contains a tree view 207 of the devices 208 and groups 209. This tree view 207 (and the several others described below) appears and operates similarly to the tree view in the well-known Windows Explorer component of Windows. An operator can through a menu command interface, drag-and-drop gestures, pop-up menus and the like:

1. Add devices to the tree.

2. Delete devices from the tree. If a device is deleted, it is removed from the groups in which is appears.

3. Create group folders.

4. Remove group folders from the tree.

5. Add devices to a group folder. Devices can be added to a group folder using drag-and-drop. Devices can be added to more than one group.

6. Remove devices from a group folder. If a device is removed from a group, it is not deleted from elsewhere the tree.

If a group is selected, the operator can, also through menu commands, drag-and-drop gestures and the like:

1. Save configuration. The configuration for all devices in the group will be saved under the same configuration name.

2. Restore configuration. A configuration previously saved from the level of the selected group can be restored. In the event that the membership of the group has changed since the group-level configuration was saved, the operator will be given a choice whether or not to restore a configuration to a device that is no longer in the group, or cancel the operation altogether. Also, for devices that have been added to the group, i.e., devices that do not have a configuration saved in this group, the operator will be notified that the devices have no configuration and the user will be given a chance to cancel the restore.

3. Survey. Selecting this operation will cause the system to perform a survey of all devices in the group.

4. Reset device. The operator can schedule the reset of all devices in the group.

5. Get a list of all devices in the group. A group may contain other groups and devices.

Thus, there may be a need to see all devices in the group. In the exemplary embodiment, this cannot be done in the tree or list view alone. Selecting a suitable menu item will pop up a dialog with a list of all devices contained in this group and any sub groups. The All Devices pop up will be a table of devices showing device name, IP address, last configuration save and date, firmware and date.

6. Get a list of all configurations in the group. Selecting another menu item will pop up a dialog with a list of all configurations performed on this group, sub groups, or devices contained in the group or sub groups.

If a group 209, e.g., GROUP 1, is selected, the right-hand side of the view 210 will contain a list view tab 211 and a configurations tab 212. The list view tab 211 presents graphical elements for navigation, multiple selection, and drag-and-drop gesturing. Pop up menus that are available from the tree are also available by selecting nodes in this view. The configurations tab 212, as shown in FIG. 3, will show the configurations 301 that have been saved at the current group level, i.e., configuration saves that were initiated from this group, GROUP 1.

If a device 208 is selected, the operator can through menu commands, drag-and-drop gestures and the like:

1. Save configuration. The configuration for the selected device will be saved.

2. Restore configuration. A configuration previously saved for the selected device, whether the configuration was saved from the device level or the group level, can be restored.

3. Download firmware. The operator can choose a firmware image to download from the pop-up dialog.

4. Survey. Selecting this operation will cause the system to perform a survey of this device.

5. Device reset. The operator can schedule the reset of this device.

If a device 208, e.g., DEV 1, is selected, the right-hand side of the view, as shown in FIG. 4, will contain a general tab 401 displaying properties, a configurations tab 402, and a history tab 403.

1. The general tab 401 will show the details 404 about the device selected. This may include zero or more items from, but not limited to, the following:

2. The configurations tab 402 will show, as shown in FIG. 5, the configurations 501 that have been saved for the selected device, including those saved directly for the individual device 502 and those saved from the group level 503, i.e., configuration saves that were initiated from the group in which this device is contained. The information could also be obtained by filtering for the device name in the configurations tab of the main view. However, the operator may find it easier to go to this location for this information.

3. The history tab 403, as shown in FIG. 6, shows the history of changes 601 to the selected device. This information could be obtained by filtering for the device name in the history window of the main view (FIG. 2, 206). However, the operator will find it easier to go to, and is more likely to go to, the device (FIG. 2, 208) in the network elements tree (FIG. 2, 207) for this information.

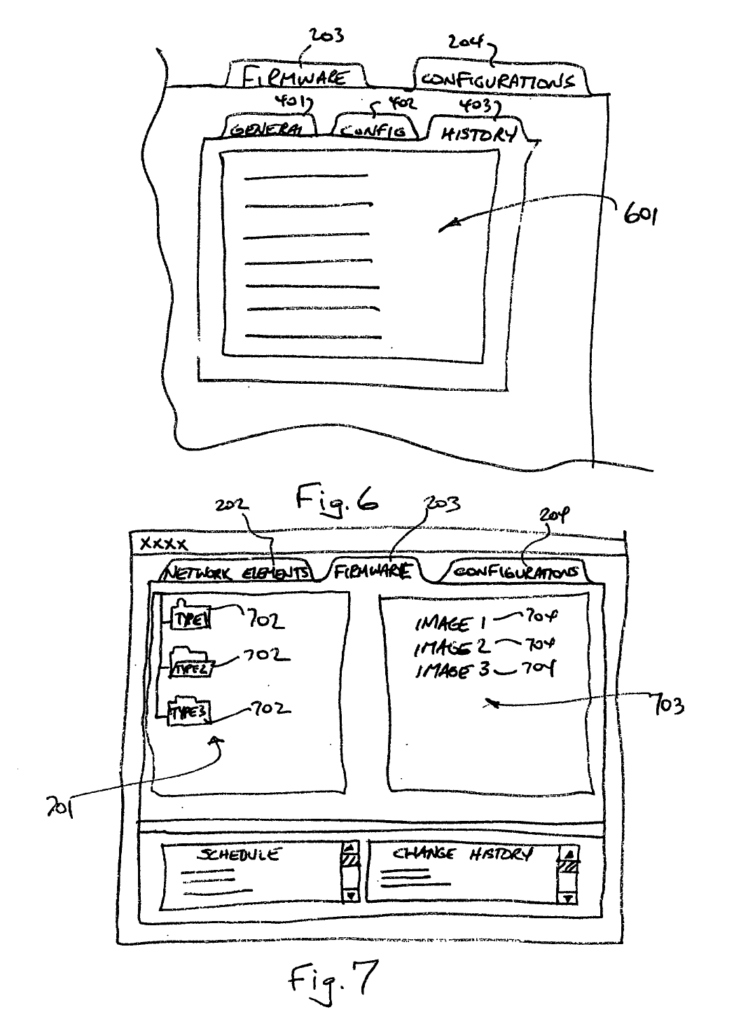

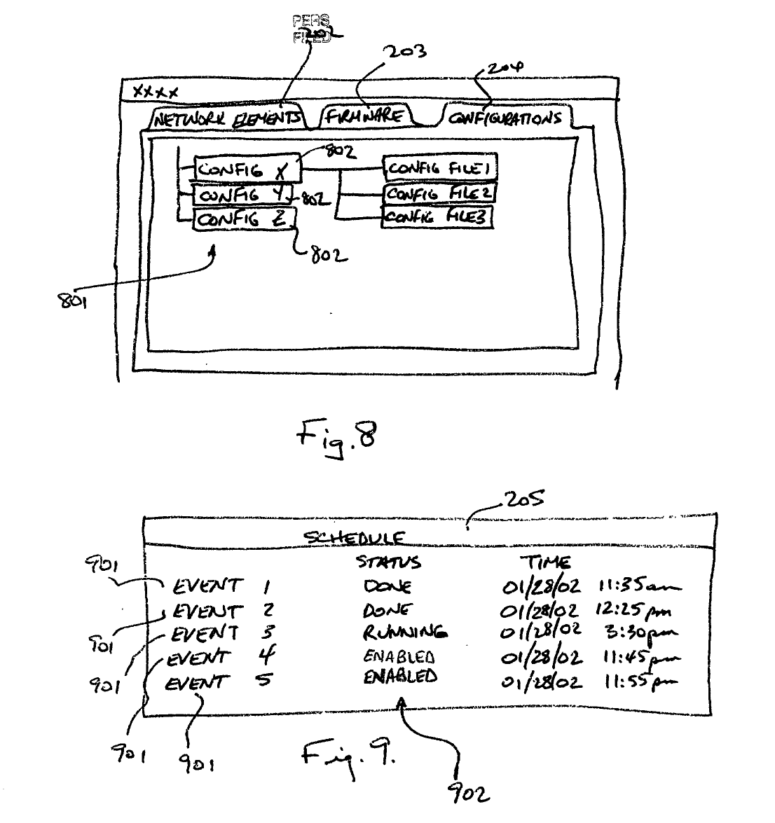

The firmware tab 203, as shown in FIG. 7, will display a tree 701 of device types 702. Selecting a device type folder 702, e.g., TYPE 2, from the tree will produce a list 703 of firmware images 704 for that device type on the right hand side of the view. From there an image 704 can be selected to download. The firmware download dialog will have a list of devices to which the firmware can be downloaded.

The tree can also be viewed by image (not shown). In this mode, the nodes in the tree are firmware images and the details view on the right hand side is a list of device types. The operator can select an image from the tree and pop up the download dialog using conventional gestures with a pointing device. The dialog will contain a list of devices to which the firmware can be downloaded.

The operator can also select a device from the network elements tree and pop up a firmware download dialog from there. This dialog will list the images available for the device.

The inventory manager “discovers” firmware images by scanning the directory in which they are stored. Thus, to add or remove firmware images, the operator simply will add the image file to or delete the image file from the directory.

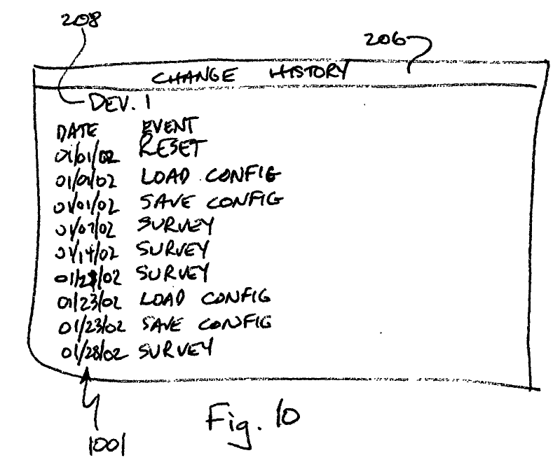

The configurations tab 204, as shown in FIG. 8, will contain a tree 801 of all the configurations that have been saved. The tree is organized by configuration save name or by date. From the configuration tree 801, the operator can select a configuration 802 and either save the configuration again or restore the configuration. The restore dialog will display one or more devices, depending on whether the configuration was saved from a group level or from the device level. This is described below.

If the tree is viewed by date, then the top-level branches of the tree will be the date stamps for when configurations were saved. The sub-folders from this view of the tree are the configuration names. In this view mode, the operator can select a configuration name folder and perform the following operations. Likewise, if the view mode is by configuration name, then the top-level branches of the tree will be the configuration names and the sub-folders will be the date stamps. In this view mode, the operator can select a date stamp folder and perform the following operations.

1. Restore configuration. The configurations in this folder will be restored to the devices listed in the folder.

2. Survey. Selecting this operation will cause the system to compare the current device configurations with the configurations in this folder.

The leaves of the configuration tree are the individual configuration files themselves. For convenience, file names are derived from the corresponding device's IP address, so the operator can tell what device the configuration belongs to. If the user selects a configuration file, the user can:

1. Restore configuration. The configuration will be restored to the corresponding device.

2. Survey. Selecting this operation will cause the system to compare the current device configuration with the selected configuration.

From the configurations tab 204, the operator can select a configuration 802, a configuration name, or a configuration save date and delete the configuration tree branch. This effectively removes the physical configuration files from the system and removes the configuration from the configuration database. This does not remove the configuration from the history database. In other words, history continues to show that the configuration was saved, but there is no other record of the configuration once it is deleted.

The schedule summary 205, as shown in FIG. 9, is a list of the events 901 that have been scheduled and their status 902. All scheduled events appear in the summary, even those that have been run. Thus, the operator can reactivate a schedule entry directly rather than having to reconstruct the event from scratch.

From the schedule window, the operator can select a schedule entry and delete it. If the schedule entry has a status of “enabled,” meaning it is in the queue waiting to be run, deleting the schedule entry 901 will remove it from the schedule queue.

The change history 206, as shown in FIG. 10, is the summary of all actions taken against a device 208. This is the view that the operator can refer to for a global view of the configuration save/restore, firmware download, survey, and device reset activity.

As events occur, the change history is updated with the status. This view, then, provides direct feedback to the operator that the action is taking place and the result of the action.

Only the date column 1001 can be sorted. This is to maintain the integrity of the view, which is meant to be a time-ordered view of the activity. Sorting on the date column only reverses the order in which the table is viewed and still maintains the sequence of events. To find a particular device, the operator can either filter the view or go directly to the device in the network elements tree.

The user interface will only allow history events to be deleted from the end of the log. Deleting events from the middle is not allowed as this violates the integrity of the view.

### The Scheduler

Returning to FIG. 1, the scheduler 102 maintains its own database 107 holding a schedule or queue of individual operations to be performed and an aggregated schedule of operations to be performed on defined groups of devices, e.g., all those of a particular type or all those installed in a particular chassis. When the time for a scheduled operation arrives, the scheduler 102 sends one or more messages to the components of the system required to perform the scheduled operation. Each operation or transaction in the system, causes one or more messages to be generated and sent to a suitable destination software component. Each message is then acted upon by the destination software component.

Primarily, the scheduler 102 handles the schedule queue 107 and communicates with the agent 104. The scheduler 102 receives schedule events from the UI 101 and adds the event to the schedule queue 107. It pulls events off the schedule queue 107 when the event is due. It then passes the event to the agent 104, by sending a message to the agent 104, where the event is processed.

The scheduler 102 stores schedule data in a database 107 on a non-volatile medium. On startup, the scheduler 102 reinitializes its queue from the stored data 107.

The scheduler 102 receives message status notifications from the agent 104. As noted above, messages contain instructions and data that the agent 104 needs to carry out an action on behalf of the scheduler 102. The scheduler 102 then updates the database 107 with the status.

At runtime, the scheduler 102 resides in the same process space as the UI 101. In other words, the scheduler 102 is run in the same virtual machine as the UI 101.

The scheduler interface is defined by six operations: get(Schedule Attributes), put(Schedule Attributes), delete(Schedule Attributes), update(Schedule Attributes), register(Scheduler Listener) and unregister(Scheduler Listener). A Scheduler Listener is a software module incorporated in other system elements that is then called by the scheduler 102 when a response is to be returned by the schedule 102 to the element incorporating the Scheduler Listener module. The Scheduler Listener is explained in greater detail, below. Each of the four operations takes one or more arguments, together comprising Schedule Attributes. Schedule Attributes may include, but are not limited to the date and/or time the operations is due, the device or device group affected by the operation and the type of operation. At least one of the Schedule Attributes is an identification of the Schedule item affected by an operation. Identification is achieved when an identifying value in a field of the schedule database 107 designated as a key field matches the value of the same field in the Schedule item. The four operations are defined as follows:

get(Schedule Attributes) returns from the schedule database 107 a record that matches the Schedule attributes;

put(Schedule Attributes) creates a new Schedule item in the schedule database 107, the new Schedule defined by the Schedule Attributes;

delete(Schedule Attributes) deletes from the schedule database 107 all Schedules matching the Schedule Attributes; and

update(Schedule Attributes) updates in the schedule database 107 an existing Schedule item identified in the Schedule Attributes by a value of a key field by setting corresponding values in the Schedule item to the values of the Schedule Attributes. An update(Schedule Attributes) operation works by a mechanism of a “get” followed by a “modify” and finally a “put” of the necessary information.

register(Scheduler Listener) adds the Scheduler Listener to a notification list of scheduler listeners; and

unregister(Scheduler Listener) removes the Scheduler Listener from the notification list.

The Scheduler Listener is defined by the single operation notify(Operation Event). The scheduler calls notify(Operation Event) for each registered Scheduler Listener whenever an Operation Event occurs. Operation Event may include, and are not limited to the Operation performed and the Operation Event type, and may also include ancillary data associated with the Operation and Operation Event type.

### The Agent

The agent 104 communicates with the devices 105. It is driven by requests from the scheduler 102. The agent 104 processes requests in a first-in-first-out (FIFO) order.

The agent 104 has no notion of time; the scheduler 102 is the only part of the system that is concerned with time of day.

The agent 104 uses event notification to inform the scheduler 102 of the status of a request. The agent 104 communicates with the scheduler 102 on the one hand and with the file transfer mechanism 110 and devices 105 on the other hand. The UI 101 and database 108 are updated indirectly by the scheduler 102, responsive to status reports by the agent 104, as well as the scheduler's own actions.

At runtime, the agent 104 can either be run in the same process as the UI 101, the scheduler 102 and the database manager 103, or in a separate process. Thus, the agent 104 can run on a remote host. The agent 104 can be run on the same host as the file transfer mechanism 110, for example a TFTP server. Running the agent 104 on the same host as the file transfer mechanism 110 is advantageous because the agent 104 can ensure that the configuration files are touched before a configuration upload begins. If the configuration file does not exist on upload, the file transfer mechanism 110 may fail to write the file. Therefore, this arrangement ensures existence checking of the required configuration files can be performed.

Having the agent 104 co-resident with the file transfer mechanism 110 has other advantages.

The agent can act as a proxy to identify configuration file differences on a remote host.

The agent can act as a proxy to perform file system maintenance on a remote host.

The scheduler can load balance across several agents.

The user whose preferred file transfer mechanism 110 is a TFTP server can use their existing TFTP server.

Because the agent 104 can run on the file transfer mechanism host, which may be remote from the other system elements, the agent 104 will also function as a proxy to do file access, transfer, and management. The scheduler 102 can send requests to the agent 104 to compare files, delete files, and write files.

The agent interface is defined by four operations: send(Operation), abort(Operation), register(Agent Listener) and unregister(Agent Listener). Operations are those actions that the agent can perform when invoked. An Agent Listener is a software module incorporated in other system elements, such as the scheduler 102, that is called by the agent 104 when a response is to be returned by the agent 104 to the element incorporating the Agent Listener module. The Agent Listener is explained in greater detail, below. The four operations defining the agent interface are defined as follows:

send(Operation) is called by the scheduler 102 to invoke the Operation on the agent 104;

abort(Operation) is called by the UI 101 to stop processing by the agent 104 of the Operation;

register(Agent Listener) adds the Agent Listener to a notification list of agent listeners; and

unregister(Agent Listener) removes the Agent Listener from the notification list.

The Agent Listener is defined by the single operation notify(Operation Event). The agent calls notify(Operation Event) for each registered Agent Listener whenever an Operation Event for each registered Agent Listener whenever an Operation Event occurs. Operation Event may include, and are not limited to the Operation performed and the Operation Event type, and may also include ancillary data associated with the Operation and Operation Event type. Types may include status indication such as “Initiated,” “Progress” and “Complete.” Ancillary data may include the number of bytes transferred, error states, configuration file paths, checksum data, etc.

### The Configuration History Database and the Database Manager

The configuration history database (part of 108) is maintained by the database manager 103, as noted above. The configuration history database 108 defines, for each point in time at which a change occurred to the configuration of at least one device in the network, which devices had which configurations. The database does not actually store the configuration files, themselves, but rather stores pointers to the configuration files and firmware files in effect at those particular points in time. As noted above, the agent stores the configuration files and firmware files (including those from the past that are part of a configuration held in the configuration history database) locally. Also as noted above, if an operator, through the History window (FIG. 2, 206), deletes a configuration, then the configuration files are deleted, but not the entries in the configuration history database.

The configuration history database 108 can be organized several different ways, while permitting the sorting and display of the information in any of those ways, in accordance with known principles of database formation. For example, configuration history can be broken down by individual device, groups of devices or sub-networks. Some of these are discussed above in connection with display options of the UI 101. Thus, an operator can recall a past configuration for all the devices of a particular type, at a time when all the devices of that type were known to be correctly configured and correctly performing. Note that the operator need not know what settings, parameters or values a correct configuration includes, merely that the configuration at the point in time was, in fact, correct. For this reason, it is helpful for the database to include records or fields containing annotations about the different configurations, such as the circumstances under which a particular configuration was produced.

The database schema is preferably organized such that each record can hold one or more attributes from the list, including:

a. the current configuration

b. system name

c. device type

d. system object id

e. system descriptor

f. assettag

g. serial number

h. MAC address

i. IP address

j. Product Information

i. Assembly number revision

ii. Assembly number

k. Security attributes

l. Hardware State

i. Empty Slots available.

ii. Memory on device, and if upgradeable

iii. CPU information

m. Current Software State Attributes

i. Last Known Status

ii. Last known Configuration/Time

iii. Last known Firmware

n. Location Information

i. Hop Count

ii. Location Field

o. Chassis Identifier, i.e., a user entered name

p. Chassis Name i.e., the Chassis Mac Address

q. Module Slot Number

r. Informational Attributes

i. Memo

If the scheduler 102 has in the schedule queue 107 periodic configuration checks, i.e., audits or surveys, then a periodic history of configuration changes is developed and stored, including those that may have been made by technicians during debug and maintenance operations, perhaps unbeknownst to the operator. Thus, if the network ceases to operate correctly, the operator can return to a known good configuration without even knowing what change the technician may have made during the debug or maintenance operation.

The agent 104 communicates with network devices 105 using SNMP and TFTP, to direct the devices 105 to perform required operations. For example, in order to ascertain the capabilities of a particular device 105, the agent 104 challenges that device 105 using SNMP with a sequence of common Management Information Bases (MIBs). When the device 105 responds to a challenge MIB, then the device's capabilities are known. The agent 104 then knows how to upload to the device 105, and download from the device 105, configuration files, firmware, etc. using TFTP, for example.

Each time the agent 104 downloads a configuration file from a network device, that configuration file is compared to the most recent past configuration file for the device 105 currently stored in the system. The comparison need not be performed on a direct, bit-by-bit basis, but may instead be the result of comparing a checksum of one sort or another, such as a Cyclic Redundancy Check (CRC), a Message Digest 5 (MD5) message digest or other checksums, as known in the art. Checksums for configuration files already stored in the system need not be computed each time needed. Rather, they can be stored in the data store 109 in which the configuration files are stored, in the configuration history database 108 or elsewhere in the system that is convenient for the purpose. Using checksums instead of complete files reduces the time for performing the comparison because less information need be transferred from one part of the system to another.

When network devices 105 are added, removed or swapped, the operator need only update a database (part of 108) mapping each device to a network address, for example an Internet Protocol (IP) address. The next time that a configuration audit, survey or update is run, for example on the basis of a scheduled time, the system will detect the new device as having a configuration, which has changed since its last update. The operator will therefore be alerted, and a decision can be made as to what configuration to use in the device—a prior configuration used for other instances of the same device 105, or the current (most likely, power-on default) configuration downloaded just prior to the alert.

The database 108 of the exemplary embodiment is implemented as a random access file with fixed length records. Databases are generically defined by the following Baccus-Naur form (BNF) definitions:

<database> ::={<record>}
<record> ::=<attribute>{| <attribute>}
<attribute> ::=<type><length><value>
<type> ::=<datatype>required | unique
<datatype> ::numeric | string
<type> ::=<digit> { | <digit>}
<value> ::=null | { <digit>} | {<any_character>}

The database according to this definition may span more than one file, may have same defined elements stored in a separate file from others or may include implicit assumptions regarding some elements, such as a predefined length for each datatype.

That database manager uses write-through access, meaning there is no caching of data prior to writing the data to disk. Thus, there is no need to have a “File→Save” operation since the data in the application is always in sync with the data on disk.

The database manager interface is defined by six operations: get(Attribute List), put(Attribute List), delete(Attribute List), update(Attribute List), register(Database Listener) and unregister(Database Listener). The Attribute List includes an Identification of the record upon which an operation is to be performed. The Identification is contained in the value of a field designated in the database 108 as a key field. The Database Listener is a software module analogous to the Agent Listener described above. The six operations of the database manager interface are defined as follows:

get(Attribute List) returns from the database 108 a record matching the Attribute List;

put(Attribute List) adds to the database 108 a record having the attributes in the Attribute List;

delete(Attribute List) removes from the database 108 all records matching the attributes in the Attribute List;

update(Attribute List) modifies a record with the values in the Attribute List;

register(Database Listener) adds the Database Listener to a notification list of Database Listeners; and

unregister(Database Listener) removes the Database Listener from the notification list of Database Listeners.

The database listener is defined by the single operation notify(Database Event). The database manager calls notify(Database Event) for each registered Database Listener whenever a Database Event occurs. Database Events may include, and are not limited to, the type of the event to be reported, such as add, delete or modify, and the record added, deleted or modified.

The exemplary embodiment is independent of the particular database implementation. A shim, i.e., a thin set of code mapping the foregoing abstract of operations to the methods and functions of the database implementation, is all that is required to connect the system to the database implementation.

Some Typical Operations

### EXAMPLE 1

One very simple operation of the exemplary system is a simple audit or survey operation. In this operation, an operator has, through the UI, placed an event on the scheduler queue, either for immediate execution or for execution at a specified point in time or for execution at a specified time interval. The event placed on the scheduler queue calls for the configuration of each network device to be downloaded from the device and compared to the configuration recorded in the configuration history database for the device.

When the time for the event in question arrives, the scheduler sends a message to the agent to perform the necessary downloads and comparisons. As configuration files for each device are downloaded, they are compared with corresponding configuration files that were stored at earlier points in time. Differences between the corresponding configuration files from different points in time are noted and indicated to the operator through the UI.

As noted above, the comparison need not be bit-by-bit, but can rely on faster methods, such as the use of checksums and the like. Audit and survey operations can include various elements of configuration, including MIB settings, configuration file contents and firmware file contents.

Since changes to device configurations are frequently out of the control of the operator, periodic audits or surveys are useful for tracking changes on a periodic basis, such as weekly, daily or hourly, depending on the maintenance activity level in the network.

This process is illustrated by FIGS. 11, 12 and 13 and the following description thereof.

The operator gestures in the UI to indicate that an audit or survey event is to be run at a particular time or interval. Gestures in the UI may include clicks, double-clicks, drags, menu picks, etc. using a pointing device, typed input, or other known types of operator input. The UI (FIG. 1, 101) modifies the contents of the event queue (FIG. 1, 107) to correspond to the operator input.

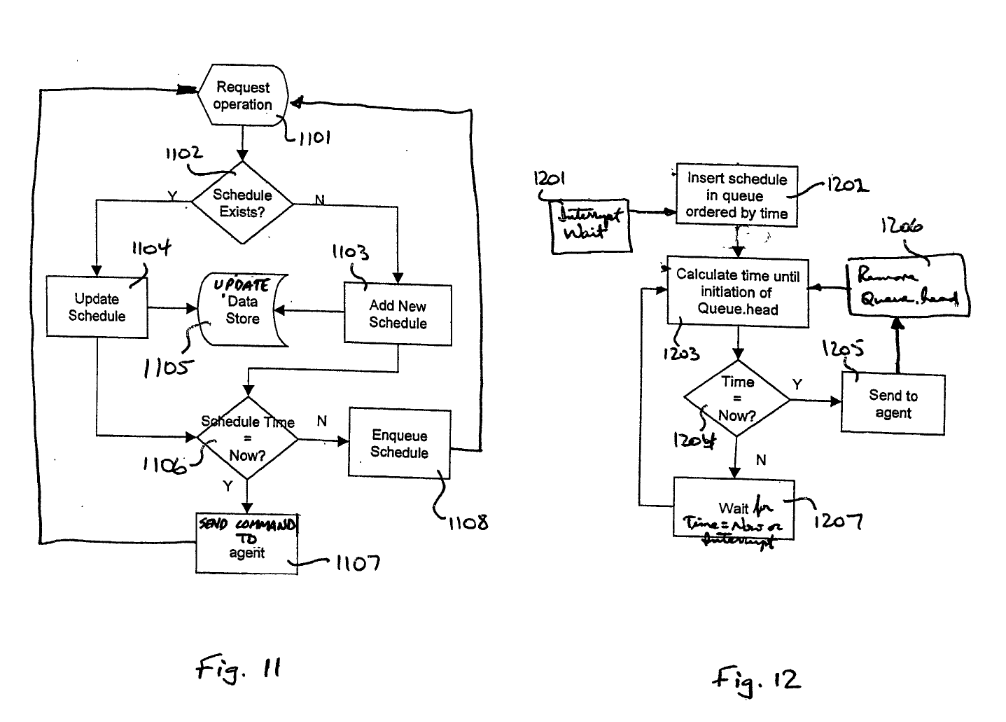

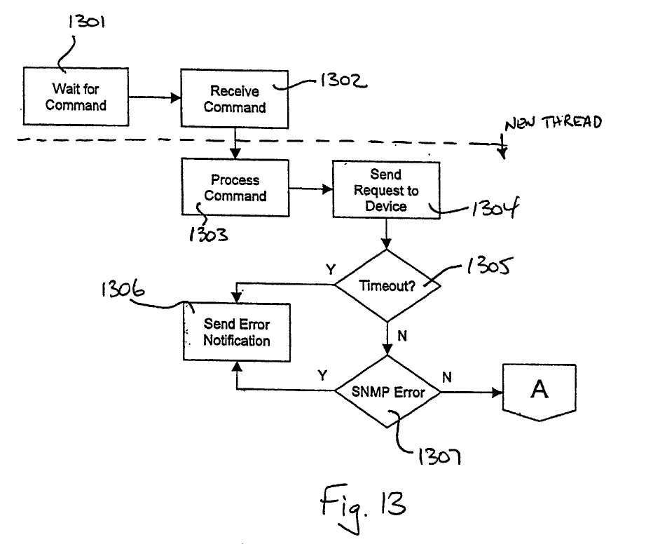

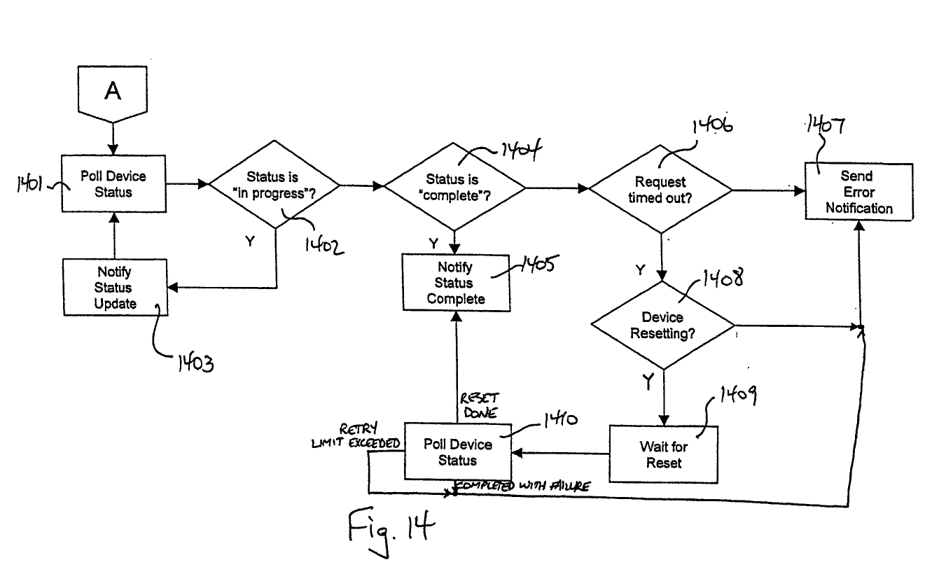

As shown in FIG. 11, the operator gestures in the UI to request an operation 1 101. The UI then determines whether the operation requested defines an existing schedule item or a new schedule item 1102. If the schedule item is new, the schedule item is added 1103 to the schedule queue non-volatile data store 1105; if old, the schedule item in the schedule queue non-volatile data store 1105 is updated 1104. The scheduler then determines if the operation requested has a schedule time of “now” 1106. If so, the scheduler sends the request to the agent 1107 (See FIG. 13 and the description below.); if not, the scheduler enqueues 1108 the schedule item (See FIG. 12 and the description below.).

Independently of the operation of the UI and any gestures made by the operator, the scheduler executes a tight loop, enqueuing new schedule items and firing off messages to accomplish the actions specified in the schedule queue, as follows, as shown in FIG. 12.

Events are queued 1201, 1202 according to the time at which they are to be performed. Whenever a schedule item is to be enqueued (FIG. 11, 1108), the scheduler queue wait state is first interrupted 1201, then the new schedule item is inserted 1202 in the queue in proper time sequence. The scheduler queue then enters its active loop by first calculating the time until initiation of the first entry in the queue, Queue.head, 1203. If the time in “now,” 1204, then the operation is sent to the agent 1205 (See FIG. 13 and the description below.). Queue.head is then removed 1206 from the queue, leaving a new Queue.head. Execution continues at 1203 with the calculation of the time until the new Queue.head. If, instead, the time is not “now,” 1204, then the scheduler queue enters a timed wait 1207, that expires when the time until Queue.head expires or an interrupt occurs. Since, if an interrupt occurs, the Queue.head item may have changed, the return from interrupt carries execution back to the time calculation 1203.

As shown in FIG. 13, the agent waits for commands 1301 from the scheduler. When the scheduler sends a command to the agent (FIG. 11, 1107 or FIG. 12, 1205), the agent receives the command 1302. Waiting for and receiving commands is an asynchronous, interrupt-driven process. The agent then kicks off one or more new threads or lightweight processes to process the command 1303, which may involve computation or data retrieval, for example. After processing the command 1303, a request will be sent to a device 1304, preferably using SNMP as discussed above. The device is monitored to see if a timeout has occurred 1305, and if so, then an error is returned 1306. If not, then the process continues as shown on FIG. 14. First the device status is polled 1401. To poll the device, the agent sends an SNMP request to the device to determine whether or not any data transfer required by the request has been completed. The status response b the device is the number of bytes transferred so far. If the number of bytes is less than the transfer size, then the status is “in progress” 1402 and the Agent Listeners are notified 1403. If the number of bytes is equal to the transfer size, then the status is not “in progress” 1402, rather the status is “complete” 1404 and the Agent Listeners are notified 1405. Otherwise, either a timeout occurred while trying to communicate with the device, or an SNMP error was returned from the device. A check for a timeout is made 1406, and if not detected, then an error is reported 1407. Moreover, if the command timed out, but did not cause the device to reset 1408 or explicitly via an SNMP request, then command is also considered failed and an error is reported 1407. A configuration download will typically cause a device to reset either automatically. If the device is resetting 1408, then wait for the device to reset 1409. The wait time is indeterminate, so in the exemplary embodiment, the agent polls the device at a regular interval 1410 until it gets a response or it has been determined that the device will never respond, i.e., a retry limit has been exceeded. When the device responds, then status is polled again and the result is returned. The poll also determined whether or not the device is in the correct configuration. If it is not, then the status is “completed with failure”, here considered a type of error. Depending on the result returned by the poll 1410, either an error notification is sent 1407 or a completion notification 1405 is sent.

In this example, the event scheduled by the operator requires the agent to download a configuration file. Every time a configuration file is downloaded, a comparison is performed by the agent between the downloaded configuration file and the most recently saved configuration file in the system. The agent will return a completion message indicating the results of the comparison. The completion message and data are passed to the database manager to update the configuration history database to account for the result of the action by the agent.

### EXAMPLE 2

Another important type of operation is updating the configuration of the network in response to a change in the hardware configuration of the network such as occurs when a network device is added, removed or swapped with another network device.

In this type of operation, the operator, through the UI Network Elements tab indicates the existence of a new device at a specified IP address, the termination of existence of a device at a specified IP address, or the exchange of a network device of one type for one of another type at the same IP address. The next time the scheduler performs an operation directed to that device, or the group containing that device, the configuration status of that device will become part of the configuration history for the network. All configurations, whether defined over a group or an individual device, ultimately are broken down to the device level for the agent to communicate with the devices. Thus, the added, removed or swapped device shows up as a difference in configuration when the next operation involving that device or the group in which that device resides is performed.

The detailed operation in this example is similar to that of the first example.

The operator gestures in the UI to indicate that a network element has been added, removed or swapped. The UI then updates the mapping database (part of 108) by sending a message to the database manager.

As before, the scheduler simply waits for the time of the first scheduled event in the queue. When an event time arrives, then the scheduler prepares a message, which is sent off to the agent, for action. Since the contents of the mapping database are used to prepare the message to the agent, in order to perform the requested event, the action performed will depend on the changes made to the mapping database. Because the agent always performs comparisons of configurations, the added, removed or swapped device is automatically flagged to the operator as a change, inviting operator approval and/or confirmation of the correct configuration.

### EXAMPLE 3

In another type of situation, a field technician may be sent to debug and correct the configuration of a remote network device. This is similar to the first example. The field technician may use a direct command line interface to the device, entirely bypassing any central control over configuration of the network. During the course of this maintenance operation, the technician may load several different test configurations into the device, in order to diagnose a particular type of problem. Sometimes, after the initial problem has been diagnosed and corrected, a new problem emerges. This new problem may be the result of improperly restoring an initial configuration that was changed in what was intended to be a temporary step as part of the debug process, but that became a permanent part of the current configuration.

In this situation, the operator can compare the current configuration with the previous known configuration to identify differences between them. The user interface can display the differences in the configuration files, without necessarily parsing the meaning.

The operator may gesture in the UI to indicate that an audit or survey event is to be run at a particular time.

The scheduler then, at the scheduled time, sends a message to the agent to perform the audit or survey. When the unexpected change is detected, the return message (FIG. 13, 1307) will so indicate. Thus, the operator can find the spurious change to the network configuration.

The present invention has now been described in connection with a number of specific embodiments thereof. However, numerous modifications, which are contemplated as falling within the scope of the present invention, should now be apparent to those skilled in the art. Therefore, it is intended that the scope of the present invention be limited only by the scope of the claims appended hereto.

What is claimed is:

1. A method of managing a computer network, comprising:
comparing a first configuration file representing a network device configuration at a point in time with a second configuration file representing a network device configuration at an earlier point in time; and
indicating when a difference exists between the first configuration file and the second configuration file.

2. The method of claim 1, further comprising:
after passage of a period of time, repeating comparing and indicating.

3. The method of claim 2, further comprising:
repeating comparing and indicating after passage of regular intervals of time.

4. The method of claim 1, further comprising:
identifying as representing a known good state, the second configuration file; and
recommending returning to the known good state by loading the second configuration file, when the difference is indicated.

5. The method of claim 1, further comprising:
storing with each configuration file an identification of a responsible operator; and
querying the responsible operator concerning a nature of the first configuration file when the difference is indicated.

6. A system for managing a computer network, comprising:
a memory in which is stored configuration files corresponding to plural network devices at plural points in time;
a database in which is stored a history of configuration file usage; and
an agent that retrieves from a network device a configuration file and determines when the configuration file retrieved differs from a stored configuration file corresponding to a different point in time.

7. A system for maintaining configuration of a computer network, comprising:
a data store of configuration files, each stored configuration file holding a configuration of a device at a time; and
an agent that downloads a current configuration file holding a current configuration from the device and compares the current configuration with the configuration of the device at the time, storing the current configuration in the data store when the current configuration differs from the configuration of the device at the time and identifying differences to an operator.
